(19) United States
(12) Patent Application Publication
(10) Pub. No.: US 2002/0032601 A1
(43) Pub. Date: Mar. 14, 2002

(54) Electronic payment parking lot system and method

(76) Inventors: Gebre Admasu, Amersfoort (NL); Michael Gurmu, Oakland, CA (US)

Correspondence Address: Ellen S. Cogen, Gifford, Krass, Grob, Sprinkle,, Anderson & Citkowski, P.C., 280 N. Old Woodward Ave., Suite 400, Birmingham, MI, 48009, US

(21) Appl. No.: 09/843,382

(22) Filed: Apr. 25, 2001

Related U.S. Application Data
(60) Provisional application No. 60/199,352, filed on Apr. 25, 2000.

(51) Int. Cl. G06F 17/60

(52) U.S. Cl. 705/13

(57) ABSTRACT

There is provided an integrated system and method for payment and enforcement of parking services. The invention utilizes a digital carrier, such as the electromagnetic energy spectrum or wired network to effect the payment transaction and enforcement. The invention typically includes interfaces for an electronic meter, web server, and motorist device. The motorist utilizes the device, e.g., cellular phone or handheld device, to access an individual account on the web server, providing information pertinent to the transaction. Upon receipt of the information, the web server verifies account information and the account balance, authorizes the transaction, and debits the motorist's account accordingly. The web server communicates with the electronic meter, which displays the paid time units or an expiration flag. The web server communicates with handheld devices of paid parking enforcement officials to provide instantaneous notification of expiration of time units and other information pertinent to paid parking services.

### REFERENCE TO RELATED APPLICATIONS

This application claims priority of U.S. provisional patent application Serial No. 60/199,352 filed Apr. 25, 2000, the entire content of which is incorporated herein by reference.

### BACKGROUND OF THE INVENTION

1. Field of the Invention

This invention relates generally to an automated payment system and method for parking services. More particularly, the invention provides, via a communication network, a fully integrated method and system for the computerized payment and enforcement of metered parking.

2. Description of the Related Art

Modem parking services often entail the use of parking meters or gated lots. Traditional parking meters correspond to individual parking spaces, typically on a street. The parking meters require a coin deposit therein as payment for the services. Once a motorist deposits the coins into the meter, the meter provides a predetermined number of time units authorized for parking, the time units corresponding to the value of the deposited coins. Typically, an indicator on the meter visually displays the time units available to the motorist. Upon expiration of the purchased time units, a flag displays for the benefit of the motorist (and law enforcement personnel).

Off-street parking services are also available to motorists. Gated lots require the motorist to take a time stamped pass from a machine situated at the entry of the lot. To exit the gated lot, the motorist must present the time stamped pass to parking a lot attendant. The parking lot attendant calculates a total charge for parking services from the time stamp on the pass. The motorist must pay the cash amount of the total charges to the parking lot attendant. Alternatively, some gated lots permit payment of the total charges by credit card. Similarly, some gated lots have card readers that accept an encoded card such as a smart card having an associated monetary value. Upon receipt of the same, the card reader debits an appropriate amount from the value of the card for satisfaction of the payment due for parking.

The payment methods of the present art, however, raise several issues. First, carrying heavy, bulky coins or cash can be very inconvenient for the motorists. Credit card payments at gated lots, for instance, requires burdensome handling procedures whereby the motorist must wait for the parking lot attendant to process the charge, produce a paper receipt, and pass to the motorist for signature. The effort involved in obtaining parking cards also creates an inconvenience. Moreover, the motorists often find themselves without the required coinage or parking card, and are forced to delay parking, seek out change or parking cards, and return to the parking area, resulting in a substantial inconvenience for the motorist in terms of time, effort, and frustration.

Alternatively, if the motorist parks a vehicle in a metered location without depositing the proper coins, the motorist risks enforcement of paid parking services in the form of a ticket. Settlement of the ticket results in fees, lost time, and excessive effort on behalf of the motorist. Similar problems exist for users of smart cards, when the monetary value of the card falls below an amount acceptable to complete a transaction for parking services. Users of paid parking services must also periodically “feed” the meter with additional monies to prevent expiration of the time units.

Second, the local or municipal government must employ a staff to collect the coins; to monitor all meters in a given territory for expiration of time units on occupied parking spaces; and to ticket motorists in violation of payment fees. Collection of the coins often results in loss of the same. Collected coins must be counted by the staff, transported to a bank, and counted again, a time consuming process with little or no return on the effort expended. Additionally, the staff that monitors the meters must brave adverse conditions to complete the tedious duty of repeatedly checking each meter associated with a parked vehicle for display of an expired flag. While the government may recoup some financial losses with monies generated from tickets, the ticketing process is arbitrary at best. Thus, a common scenario offers free parking services to the motorist who leaves a vehicle in the parking spot after the paid services expires, and, after some period of time, drives off in the vehicle without notice or ticketing by the enforcement personnel.

Finally, vandals often damage meters to steal the coins stored therein, resulting in repair and replacement costs for the meter as well as the financial loss associated with the stolen coins. Additionally, the municipality suffers a loss of potential revenue until such time as the parking meter is replaced and operational. Such losses may be imputed to taxpayers, adding to the overall individual costs associated with paid parking services.

It is desirable, then, to provide a comprehensive, automated parking services payment system having payment means that are always funded and easily transportable by a motorist. Further, the system should provide law enforcement personnel with immediate information pertinent to the remaining time units for occupied parking spaces. Such information should be locally and remotely available to the law enforcement personnel, without regard to the physical proximity of the law enforcement officer to the lot or parking space in question. Finally, the system should incorporate features that provide efficient accounting measures, prevent the theft of monies received for parking services, and discourage damage to the parking meters associated with the parking services.

### SUMMARY OF THE INVENTION

The present invention addresses the issues of the current art with a digital system that provides a fully integrated payment and enforcement system for parking services. The system and method eliminates the need for coin or parking card payments to procure such services. Rather, the invention provides convenience, efficiency, and cost-effectiveness via a communication network such as a wireless network or the Internet. Further, the system provides the means to immediately fund a payment account from any location, and access that account for remote payment of parking services. Additionally, it is noted that the media utilized by motorists to pay for parking services are inexpensive and highly mobile.

Advantageously, the system also provides parking payment enforcement capabilities including the ability to instantaneously determine, from a remote location, if the purchased time units for a given parking space have expired. Another advantage of the system of the present invention is the nonuse of coin or currency payment, thereby eliminating motivating factors for theft and vandalism. Moreover, the electronic or digital payment means utilized in the present invention permit instantaneous, accurate accounting measures for individual parking accounts as well as the entire parking payment system.

Preferably, the system includes a remote parking authorization interface (RPA interface), a motorist interface, an enforcement interface, and an optional meter interface. The motorist interface embodies a program designed to interact with communication media such as cell phones, WAP-phone, handheld computer devices, and cards. The motorist interface resides locally on such devices. Alternatively, the motorist interface resides on a remote device, e.g., a web server, and the motorist accesses the motorist interface via a communication network. The motorist interface interacts with the RPA interface, and, in certain embodiments, with a meter interface, as hereinafter described.

The RPA interface typically resides on a web server or other computing device located, for instance, in the municipal building that manages parking services. The RPA interface manages the payment services, typically comprising one or more computer programs. The programs accomplish various functional objectives, including authorization of parking services; transfer of monetary credits or value to and from user accounts; monitoring and notification of expired services to devices of enforcement personnel; and a full suite of accounting services to reconcile individual accounts, total and subtotal credits for selected time periods, geographical regions, individual parking spaces, and the like.

The enforcement interface comprises the means necessary for enforcement personnel to efficiently and accurately identify parking spaces, ascertain their availability, receive notification of expiration of paid time units on a given parking space, and communicate with the RPA interface for various and related data. Typically, the enforcement interface includes one or more programs, and resides on a handheld device having a display means and an input means.

Various embodiments include a meter interface that communicates with the RPA interface, the motorist interface, the enforcement interface, or any combination of the preceding.

The foregoing examples represent several of the embodiments of the present invention; however, one skilled in the art will recognize that the examples in no way limit the invention disclosed herein.

### BRIEF DESCRIPTION OF THE DRAWINGS

FIG. 1 schematically illustrates a system according to the present invention having an RPA interface, a motorist interface, an enforcement interface, and a meter interface;

FIG. 2 schematically illustrates components associated with the RPA interface;

FIG. 3 schematically illustrates components associated with the motorist interface; and

FIG. 4 schematically illustrates components associated with the enforcement interface.

### DETAILED DESCRIPTION OF THE PREFERRED EMBODIMENT

In accordance with the present invention, a preferred system is provided to effectuate the automated payment and enforcement of paid parking services. The system includes a motorist interface, a remote parking authorization interface (RPA interface), an enforcement interface, and a meter interface. The RPA interface includes a plurality of accounts, each account associated with a motorist. The accounts contain a digital value representing a monetary amount available for payment of parking services. The RPA interface also performs such functions as checking account balances, crediting and debiting accounts, authorizing payment and parking for motorists, and notifying enforcement personnel of expired meters. The motorist interface communicates with the RPA interface to ascertain an account balance and receive authorization for parking. The enforcement interface receives notification of expiration of paid parking services, and information pertinent to the particular paid parking space. The meter interface receives information relevant to the amount of time for which services have been paid, displays the same, and displays an expiration notice upon expiration of the time.

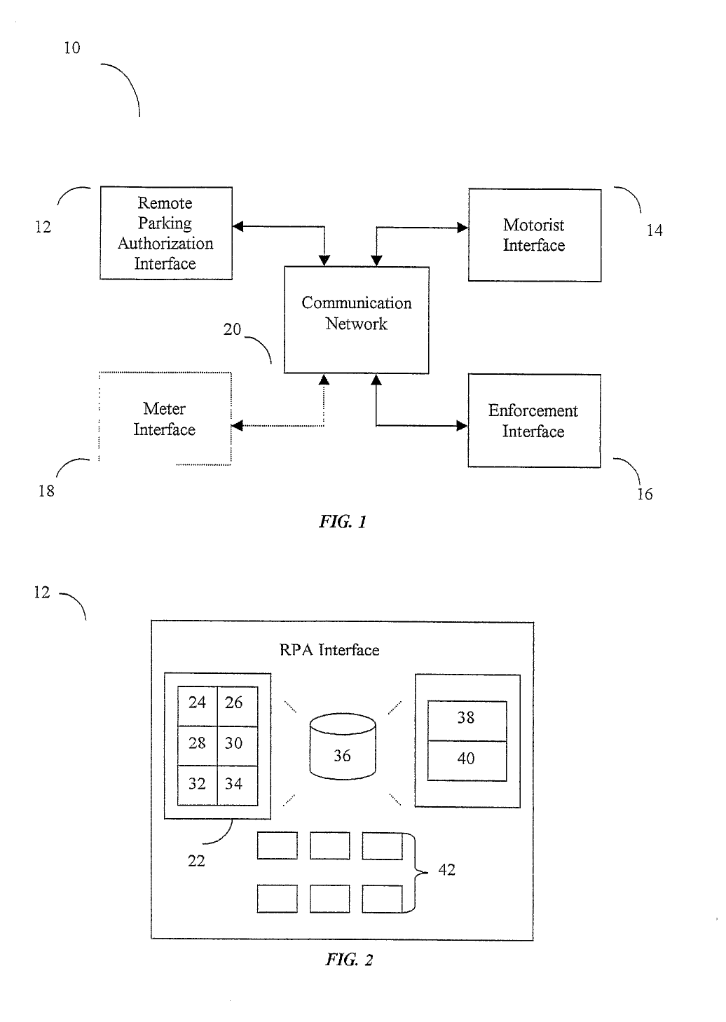

Referring now to the drawings wherein like numbers are used to denote like items throughout, FIG. 1 shows, in block diagram, the preferred Digital Payment System for Parking Services (DPSPS) 10 according to the present invention. The DPSPS typically includes a remote parking authorization interface (RPA interface) 12, a motorist interface 14, an enforcement interface 16, and meter interface 18 (depicted in phantom lines), each of the previous in communication with at least one other component via a communication network 20. It is contemplated that the communication network comprises any data carrier or combination of carriers capable of transporting data and information thereover for purposes of sending or receiving information to/from various components of the instant invention. The carriers include all forms of information transferal available via the electromagnetic energy spectrum, for example, infrared, microwave, long or short radio wave methods. The carriers further include wired networks such as the Internet. It is contemplated that the communication network is not constrained by geographical boundaries, but easily accessible globally.

Turning now to FIG. 2, there is shown a subsystem of the present invention, the RPA interface 12. Preferably, the RPA interface physically comprises one or more computer programs and data storage housed on the web server. The RPA interface logically includes a plurality of accounts 22 for the motorists, each account in the plurality of accounts containing fields for information pertinent to a particular motorist. Typically, the fields of information include an account identifier 24; a motorist name 26; a license number 28; contact information 30; funding information 32; and a current balance 34 of funds available in the account 22 for parking services.

To establish an account, a unique account identifier 24 is created. Each motorist then provides his name, address, telephone number, and a list of all license numbers, as applicable to the motorist's vehicles. The motorist further provides contact information 30 for receiving data from the RPA interface 12. The contact information typically includes the number of a cellular phone or email address associated with a device used by the motorist to access the communication network.

The funding information 32 generally includes a credit or debit account number of the motorist as well as written authorization from the motorist to charge the credit or debit account in a predetermined amount against the motorist's credit card to initially fund the account 22. The motorist also authorizes a replenishment of funds into the account 22 if the balance 34 falls below a predetermined threshold. For example, the motorist initially authorizes a transfer credit equal to $10 from a credit card to the account 22. Thereafter, the each time the balance 34 falls below an amount equal to $2, the RPA interface 12 automatically charges the credit card and credits the account 22 in an amount that brings the balance 34 of the account 22 to $10.

A repository 36, such as a database, houses the plurality of accounts 22 and associated information. The repository 36 may reside on the web server associated with the RPA interface 12, or on other media associated with, or in communication with, the web server.

Further, the repository 36 also contains a framework to house data that identifies a plurality of parking spaces 38 (or lots). Each parking space identifier 38 in the plurality of parking spaces identifiers 38 uniquely identifies the parking space, the lot, and the location of the parking facility; e.g., crossroads nearest to the parking facility. Further information pertinent to the parking space may be added, such as the maximum time allowed for continuous parking and the date and time allocated for cleaning that part of the street, etc. Dynamic directional information may be ascertained with regard to a parking space identifier 38 and the parameters for an address separate therefrom. Upon receiving both pieces of information, the RPA interface calculates the fastest route, and provides directions from/to based on the same. Dynamic directional information facilitates fast response by enforcement personnel to an incident at a given parking space, e.g., expired time meter, as hereinafter described. For example, in some embodiments, the motorist can report an incident simply by contacting the web server via cell phone and identifying the parking space vocally or through keypad input. The web server receives the information and relays the incident information along with dynamic directions calculated from the parking space identifier 38 to the proper authorities, thus enabling a fast response to a critical or other situation.

Historical/statistical information 40 contains a cross section of information related to the parking services according to various criteria. For example, the web server keeps a continuous record of an amount of money earned per meter, per lot, per region etc. across various time periods such as a day, week, month, or year.

The suite of accounting programs 42 functions to meet a variety of predetermined accounting-related objectives. For example, an accounting program reconciles the amount of parking tolls collected across the municipality in one day with the amount deposited in the bank for the same time period, thus acting as a check and balance system for monies realized from paid parking services.

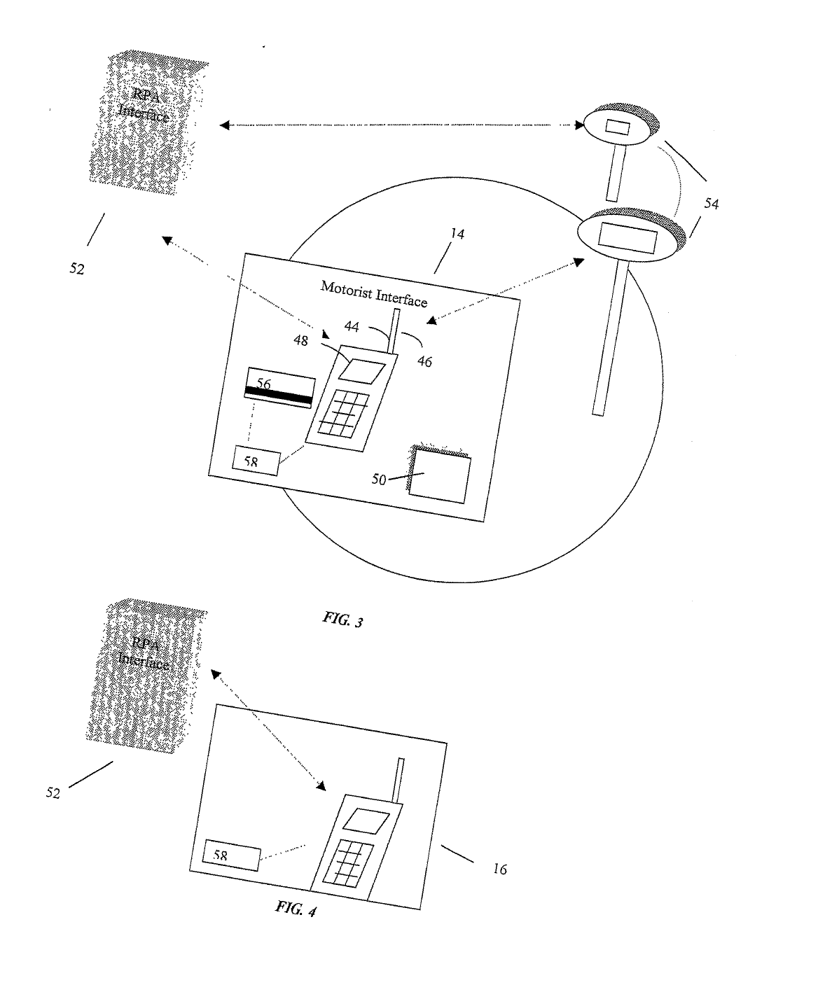

Turning now to FIG. 3, there is shown a subsystem of the present invention, the motorist interface 14. The motorist initially registers or activates an account with the municipality offering paid parking services, or other agency managing the same. It is contemplated that the motorist registers the account via a web server accessible to the Internet, the web server having a registration form. Alternatively, the motorist contacts the appropriate agency via cellular or wired telephone, and provides the required information. Typically, the information provided to activate an account includes the name of motorist; address of the motorist; contact information such as email; cell phone number, or other; and credit/debit card information against which the monetary value for the account is charged, as discussed above. Once the account contains a positive monetary balance, the motorist may begin to order parking services against the balance.

The motorist interface 14 typically includes a transmitter 44, a receiver 46, and a visual display component 48. Various embodiments include one or more computer programs 50 residing on the device used by the motorist.

The transmitter 44, receiver 46, and visual display component 48 may be embodied in a cellular telephone, handheld computing device, or other device capable of carrying out the functionality described herein. The device embodying the components of the motorist interface 14 may be voice, text, or tactile activated. For example, if a cellular telephone (cell phone) is utilized, the motorist may key in the phone number for a web server 52 associated with the RPA interface 12. Upon connection, the motorist either uses the keypad of the cell phone or speaks into the cell phone to indicate the parking space identifier 38 of a parking meter 54 for which payment is offered.

The transmitter 44 and receiver 46 of the motorist interface act to send and receive respectively data to and from the web server 52 and the parking meter 54 via the communication network. Data sent from the motorist interface 14 to the RPA interface 12 may be received via various software programs, processed, and an appropriate response sent to the motorist interface 14. For example, the data may be received as voice activation, voice recognition, or text. Data received by the motorist interface 14 from the RPA interface 12 may be displayed on the visual display component 48. For example, if the motorist utilizes a handheld device with wireless connectivity capabilities, the RPA interface may transmit confirmation of payment, amount of payment, time units purchased, and time of expiration, the same of which is displayed on the visual display component 48 of the handheld device.

In various embodiments of the present invention, the motorist interface 14 includes an intelligent card 56. The intelligent card 56 functions as a two-way communication device between the motorist and the RPA interface 12. The intelligent card incorporates, for example, a sixteen-bit microprocessor and two serial ports. Once serial port connects to the Bluetooth 58, hereinafter described. The other serial port connects to the meter 54. The intelligent card 56 is typically encoded with identifying information pertinent to the motorist.

The Bluetooth 58 incorporates a microchip transceiver that functions as high-speed transfer mechanism for both voice and data, and transmits for distances approximating 300 feet. If the wattage used to power the Bluetooth 58 is decreased, the transmission radius becomes about 30 feet. If used in conjunction with motorist interface 14, the motorist can use the cell phone, pager, or handheld device to communicate with both the meter interface 18 and the RPA interface 12. It is contemplated that a plurality of Bluetooth 58 transceivers will be implemented to propagate the carrier signal, and its accompanying data, from one interface to the next.

With reference now to FIG. 4, there is shown a subsystem of the present invention, the enforcement interface 16. Enforcement personnel utilize the enforcement interface to send and receive information to and from the web server 52 having the RPA interface 12. Typically, the information received comprises a list of meters corresponding to occupied parking spaces, the location of the meter, and the time at which the services expire. With this information, the enforcement officer can quickly and accurately ascertain occupied parking spaces having expired meters, as well as the location of such meters, and ticket the motorist accordingly. The enforcement interface 16 typically includes the means to send and receive data embodied for example, within a handheld device. The enforcement interface 16 may include a Bluetooth 58 microchip, enabling transmissions to and from parking meters.

One embodiment of the present invention includes a cell phone having a Bluetooth 58 transceiver, the RPA interface 12 located on a server, a meter interface having a Bluetooth 58 transceiver, and enforcement interface 16 having a Bluetooth 58 transceiver. By scenario, the motorist utilizes the cell phone to contact the server via the Bluetooth 58 transceiver. Upon verification and authorization by the RPA interface 12, the motorist indicates the amount of money or the amount of time requested for a given parking space. The RPA interface 12 calculates the total time or the total amount based on the input parameter from the motorist, checks the balance in the motorist's account, and, if sufficient funds are available, debits the account accordingly. The RPA interface 12 sends notification via cascading Bluetooth 58 transceivers to the Bluetooth 58 transceiver in the cell phone. The notification includes verification of the completed transaction and the time at which the paid time units will expire. The RPA interface 12 also sends notification via the cascading Bluetooth 58 transceivers to a display component of the meter, whereafter the minutes left till expiration, a flag, or other symbolic information is displayed. Finally, the RPA interface 12 sends data to the enforcement interface, e.g., a handheld device, via the cascading Bluetooth 58 transceivers. The enforcement interface displays on the visual display component 48 of the handheld device the parking space identifier 38, its location, and the time of expiration.

An alternative to the embodiment described above contemplates use of a cell phone without the Bluetooth 58 transceiver, wherein the communications between the cell phone and the RPA interface 12 are effected via typical cellular communication channels.

Another alternative to the embodiment described above contemplates the motorist interface 14 embodied in an intelligent card 56, the intelligent card 56 having an embedded Bluetooth 58 transceiver. The motorist utilizes the intelligent card 56 and its serial port to contact the RPA interface 12 for consummation of a payment transaction. The RPA interface 12 responds to the intelligent card 56, which uses its Bluetooth 58 transceiver to transmit the transaction details to a Bluetooth 58 transceiver in the meter interface 18, and display the details on a display device of the parking meter.

Yet another alternative to the embodiment described above contemplates the use of wireless connectivity to satisfy payment for off-street parking services in a gated lot. The motorist gains entry to the gated lot via a computerized machine that issues to the motorist a time stamped ticket having a unique identification number. Upon exit from the lot, the motorist utilizes the motorist interface 14 embodied as a cell phone without Bluetooth 58 capabilities. The motorist contacts the web server 52 having the RPA interface 12 via the cell phone, and conducts the payment transaction in the following manner. Upon connection to the web server 52, the motorist enters, via the cell phone, the account identifier 24 and the unique identification number located on the time stamped ticket. The cell phone transmits the unique identification number via cellular network to the web server 52 and the RPA interface 12. Upon receipt of the unique identification number, the RPA interface establishes a connection with the computerized machine, and verifies the entry time of the vehicle of the ticket holder. The RPA interface calculates charges based on the elapsed time from entry to the gated lot, plus a reasonable unit of time to permit the motorist to access his car and drive to the exit gate. The RPA interface deducts the charges from the account 22 associated with the received account identifier 24. The RPA interface transmits confirmation of the transaction to the computerized machine at the gate and to the motorist via the cell phone. To exit the gated lot, the motorist simply inserts the ticket into the computerized machine, whereafter the computerized machine check the unique identification number and verifies that proper payment has been received for a time period corresponding to the time stamp of the ticket and the actual time of exit.

Similar thereto, a motorist having a cell phone with Bluetooth 54 capabilities accesses the Bluetooth 58 transceiver at the computerized machine near the gate via his cell phone, and enter his account identifier 24. The Bluetooth 54 transceiver of the computerized machine forwards the account identifier 24 to the RPA interface 12, which checks the balance in the account 22, and sends authorization for entry to the Bluetooth 54 transceiver of the computerized machine. The machine permits entry by the motorist. Upon exit from the gated lot, the motorist beams to the Bluetooth 58 transceiver of the computerized machine, which deducts the appropriate charges from his account 22.

If the motorist chooses to use an intelligent card 56 for payment at a gated lot, the motorist presents the intelligent card upon entry to the gated lot. The computerized machine records the entry time and the account identifier 24 from the intelligent card 56. Upon exit from the gated lot, the motorist again presents the intelligent card 56 to the computerized machine, whereupon appropriate charges are calculated and deducted from the account 22.

Further features include the ability, prior to or upon entry to a lot, for the motorist to ascertain the amount and location of unoccupied parking spaces. This information can be dynamically stored and updated at the server level, and accessed from any location by the motorist via the various means of RPA interface access discussed herein. Additionally, various programs of the RPA interface can provide to the motorist various levels of directions and maps pertinent to regional and municipal parking, individual lots, or even individual parking spaces, thus preventing the motorist from futilely searching for lots with open spaces and the location of the open space within a lot. Further, the RPA interface can provide various reports in different formats, the reports derived from the historical/statistical 40 data stored on the server.

Various embodiments contemplate communications to from the RPA interface 12 to the motorist interface 14 in the form of an alert signal. The alert signal notifies the motorist of impending expiration of paid time units. The motorist interface may relay the alert signal as a visual flag on the visual device component 48 of a cell phone or handheld device; as an audible signal via a cell phone; or as a tactile signal via a beeper or similar device. The motorists may utilize the motorist interface 14 to add time to the meter of the occupied space via the RPA interface 12.

Numerous modifications, variations and adaptations may be made to the particular embodiments of the invention described above without departing from the scope of the invention defined in its claims.

I claim:

1. A digital payment system for parking services, the digital payment system utilizing a communication network and comprising:
a motorist interface accessible to the communication network;
a remote parking authorization interface having account data and meter data, the remote parking authorization interface interacting with the motorist interface via the communication network; and
an enforcement interface, the enforcement interface communicating with the remote parking authorization interface via the communication network.

2. The digital payment system of claim 1, wherein the communication network further comprises a wireless network.

3. The digital payment system of claim 3, wherein the communication network further comprises short-wave connectivity technology.

4. The digital payment system of claim 1, further comprising a meter interface interacting with the motorist interface, the remote parking authorization interface, and the enforcement interface.

5. The digital payment system of claim 1, wherein the remote parking authorization interface further comprises a plurality of accounts.

6. The digital payment system of claim 5, wherein each account in the plurality of accounts further comprises a unique account identifier, a motorist name, number of vehicles, license numbers of vehicles, contact information for motorist device, funding information, and balance.

7. The digital payment system of claim 1, wherein the remote parking authorization interface further comprises a repository for storing the accounts.

8. The digital payment system of claim 1, wherein the remote parking authorization interface further comprises a plurality of parking space identifiers.

9. The digital payment system of claim 8, wherein the remote parking authorization interface further comprises time unit information pertinent to a particular parking space identifier.

10. The digital payment system of claim 1, wherein the remote parking authorization system further comprises historical and statistical information.

11. The digital payment system of claim 1, wherein the remote parking authorization system further comprises a suite of accounting programs.

12. The digital payment system of claim 1, wherein the motorist interface further comprises a transmitter.

13. The digital payment system of claim 2, wherein the motorist interface further comprises a receiver.

14. The digital payment system of claim 1, wherein the motorist interface further comprises a visual display component.

15. The digital payment system of claim 1, wherein the motorist interface further comprises one or more computer programs.

16. The digital payment system of claim 1, wherein the motorist interface further comprises an intelligent card.

17. The digital payment system of claim 1, wherein the motorist interface further comprises a short-wave transceiver.

18. The digital payment system of claim 1, wherein the enforcement interface further comprises a short-wave transceiver.

19. The digital payment system of claim 4, wherein the meter interface further comprises a short-wave transceiver.

20. A digital payment and enforcement system for parking services, the payment system utilizing a wireless network and comprising:
a motorist interface having a short-wave transceiver accessible to the wireless network;
a remote parking authorization interface having account data, meter data, and a short-wave transceiver, the remote parking authorization interface interacting with the motorist interface via the wireless network;
an enforcement interface having a short-wave transceiver, the enforcement interface communicating with the remote parking authorization interface via the wireless transceiver; and
a plurality of meter interfaces, each meter interface in the plurality of meter interfaces having a short-wave transceiver, each meter interface in the plurality of meter interfaces communicating with the remote parking authorization interface, the motorist interface, and the enforcement interface.

21. A method for payment and enforcement of parking services, the method comprising the steps of:
providing a motorist interface accessible to the communication network;
providing a remote parking authorization interface having account data and meter data, the remote parking authorization interface interacting with the motorist interface via the communication network; and
providing an enforcement interface, the enforcement interface communicating with the remote parking authorization interface via the communication network.
